(19) United States
(12) Patent Application Publication
(10) Pub. No.: US 2016/0166923 A1
(43) Pub. Date: Jun. 16, 2016

(54) Online Interactive Game Using QR Codes

(71) Applicant: Sunder Rathnavelu Raj, Marlboro, NJ (US)

(72) Inventor: Sunder Rathnavelu Raj, Marlboro, NJ (US)

(21) Appl. No.: 14/569,703

(22) Filed: Dec. 13, 2014

(51) Int. Cl. A63F 13/213; A63F 13/69

(52) U.S. Cl. CPC A63F 13/213; A63F 13/69

(57) ABSTRACT

An online, interactive game using a set of physical game pieces; each piece has a distinct drawing object and a corresponding QR Code object. QR Code object encodes a Universal Resource Locator (URL) that specifies the corresponding web page on the World Wide Web. Players use a client device such as a smart phone to scan the QR code on respective game pieces, thereby decoding the URL and accessing first web page comprising a set of questions, hints, answers and instructions for game play. Each player taking turns to pose or present their questions or trivia facts to the rest of the players and keeping score of the number of correct answers for each player. An embodiment is described wherein game pieces are utensils used for drinking and eating with drawing and QR code objects.

### FIELD OF INVENTION

Present invention relates generally to an interactive, online game using physical game pieces with Quick Response (QR) codes.

### BACKGROUND

### Prior Art and References

The following is a listing of some prior art that appears relevant:
1. U.S. Pat. No. 8,827,160 B1, Game sequences initiated by scanning of QRcodes, Publication Date Sep. 9, 2014, Inventors Andrew Pascal, David Pascal
2. US 20130085826 A1, Game system and method of providing information, Publication Date Apr. 4, 2013, Inventor Tom Woolley
3. US 20140048590 A1, Game with Barcodes, Publication Date Feb. 20, 2014, Inventor Ian Britt

### BACKGROUND

Widespread access to the Internet on client devices such as smart phones and computing tablets has spawned a new class of games that were not possible before. These client devices incorporate a camera that can be used with the appropriate software to scan bar codes as well as quick response (QR) codes. These client devices also have the ability to access web pages from the World Wide Web via a data communication channel setup through the wireless cellular network. An embodiment described in this application is an online game that uses a set of game pieces with an imprinted drawing and a corresponding QR code. Players scan the QR code to access web pages and thereby displaying a set of web pages corresponding to the QR code on the player's game piece. In one embodiment, each game piece in the set has a different QR code thereby downloading a different first web page. Web pages have a set of questions related to the drawing, shape or other characteristic of the game piece. One embodiment uses utensils used for drinking or eating as game pieces.

To our knowledge, there are no prior art solutions that have the same characteristics as the embodiments described in this application. For example U.S. Pat. No. 8,827,160 B1 describes use of a QR code to detect the physical location of a player and thus enable certain class of games that make use of the location information. QR codes, each coded to a different physical location when scanned will allow corresponding web page corresponding the specific physical location to be displayed. This is different from current application where a game is played by a set of players using distinct QR codes on physical game pieces.

US 20130085826 A1 describes a method wherein a QR code is embedded in a product advertisement. Upon scanning this advertisement, the user is taken to an online quiz related to the product and has a chance to win a prize. Embodiments described in current application use a set of game pieces each with a distinct QR code that result in different set of questions that players use to compete with each other, thus is different from the game described in 20130085826 A1.

US 20140048590 A1 describes a system where a QR code printed on a card and related to a physical product, enables a user to buy the physical product online by scanning the QR code. As is evident from the examples of prior art, none of them have characteristics of embodiments described in the present application.

### BRIEF SUMMARY

An online, interactive game using a set of physical game pieces; each piece has a distinct drawing object and a corresponding QR Code object. QR Code object encodes a Universal Resource Locator (URL) that specifies the corresponding web page on the World Wide Web. Players use a client device such as a smart phone to scan the QR code on respective game pieces, thereby decoding the URL and accessing first web page comprising a set of questions, hints, answers and instructions for game play. Each player taking turns to pose or present their questions or trivia facts to the rest of the players and keeping score of the number of correct answers for each player. An embodiment is described wherein game pieces are utensils used for drinking and eating with a drawing and QR code objects.

### BRIEF DESCRIPTION OF THE SEVERAL VIEWS OF THE DRAWING

In order that the invention may be more fully understood, it will now be described, by way of a preferred embodiment, with reference to the accompanying drawings in which:

FIG. 1 is a block diagram of a system supporting two players with QR code recognition, decoding of the URL, accessing the corresponding web page.

FIG. 2 shows one embodiment with a set of 12 drink cups with the subject theme of “cities of the world”.

FIG. 3 shows the QR codes used in the preferred embodiment along with the respective encoded URLs and the names of the respective game pieces used in one embodiment.

### DETAILED DESCRIPTION

Primary object of one embodiment is an interactive, educational game using a set of game pieces. Each physical game piece has at least a drawing object and a corresponding QR Code object. QR Code object encodes a Universal Resource Locator (URL) that specifies the corresponding web page on the World Wide Web. Drawing and QR code objects may be imprinted on or detachably attached to game pieces.

Yet another object of one embodiment is for the players using a client device to scan the QR code on respective game pieces, thereby decoding the Universal Resource Locator (URL) thereby accessing first web page comprising a set of questions, hints, answers and instructions for game play.

An object of one embodiment is for a set of players each having a game piece to access questions that will be posed to the rest of the players in the game. Each player taking turns to pose their trivia questions to the rest of the players and keeping score of the number of correct answers for each player.

An object of the game is to declare a winner based on highest score at the end of agreed upon number of rounds of game play. Yet another object of one embodiment is to provide a game that teaches the subject matter which forms the theme of the game.

Method and system for playing an online, interactive game using quick response codes (QR code) is described below. The game is played with one or more players.

In the following description, numerous specific details are introduced to provide a thorough understanding of, and enabling description for, the embodiments described herein. One skilled in the relevant art however will recognize that these embodiments can be practiced without one or more of the specific details, or with other components, systems etc. In other instances, well-known structures or operations are not shown, or are not described in detail, to avoid obscuring aspects of the disclosed embodiments.

Game play in the present invention makes use of a smart client device such as a smart mobile phone. Game play requires two widely available capabilities in a client device; a QR code scanner and Web browser functionality.

A QR code is a two dimensional bar code. QR codes are used to encode a variety of text or numeric strings. One widely used application of QR code is to encode an URL. URL in turn specifies a web page on the World Wide Web. Client devices such as mobile smart phones as well as tablets have the ability to decode the QR code using the built-in camera and appropriate software. The web browser functionality of the client device uses connectivity to the internet via the web browser application program to be able to access the World Wide Web and display the text and multimedia content of the downloaded web pages. Widely available software application programs on the client devices allow scanning a QR code, decode the URL therein, and open a web browser application and thereby load the web page specified by the URL. This widely available capability is used in the present invention.

At the start of a game, the game pieces are distributed among one or more players. The first player uses the client device to scan the QR code on his/her game piece and access the web page using the URL encoded in the QR code. The web page displays a number of questions, their answers, hints and other multimedia objects for the player to choose from. The player selects one question from this list and poses the question to the remaining players. If multiple players indicate their ability to give the answer, then a player is selected based on a round robin or roll of dice to provide an answer. The first player checks the answer given against the correct answer displayed on the web page. If the answer is correct, then the player giving the correct answer advances his/her score. If none of the players is able to provide the correct answer, the first player provides additional hints or other multimedia cues from the said first web page or by navigating to subsequent web pages from said first web page. The game now proceeds to the second player where the same game play is repeated using a different game piece. After a number of rounds, the game is stopped and the scores tallied. The player with the highest score is declared the winner.

In another embodiment of the invention, a subset of game pieces may have the same drawing object and QR code object. These game pieces may be distinguished from each other by virtue of some other physical characteristic such as the color or shape of the game piece. This allows the individual players to identify their game piece. Players having such game pieces will have the same QR Code object and subsequently will be served the same first web page. However consecutive players in the game play can skip the questions already covered by previous players. In another embodiment, the first page gives plurality of other links whereby different players select different links thereby navigating to different sets of questions for each player.

In yet another embodiment the game is played by one player. The player uses the game play as an educational tool to learn about the drawing object or an object related to the drawing object by studying the set of questions, answers and multi-media presentations contained in the web page corresponding to the game piece.

In another embodiment of the present invention, the client device has embedded application software that allows it to display pages and multimedia content required for the game play from local storage instead of accessing the web pages on the World Wide Web. Wherein locally stored web pages are cached versions previously loaded from the World Wide Web.

### Detailed Description of the Preferred Embodiment

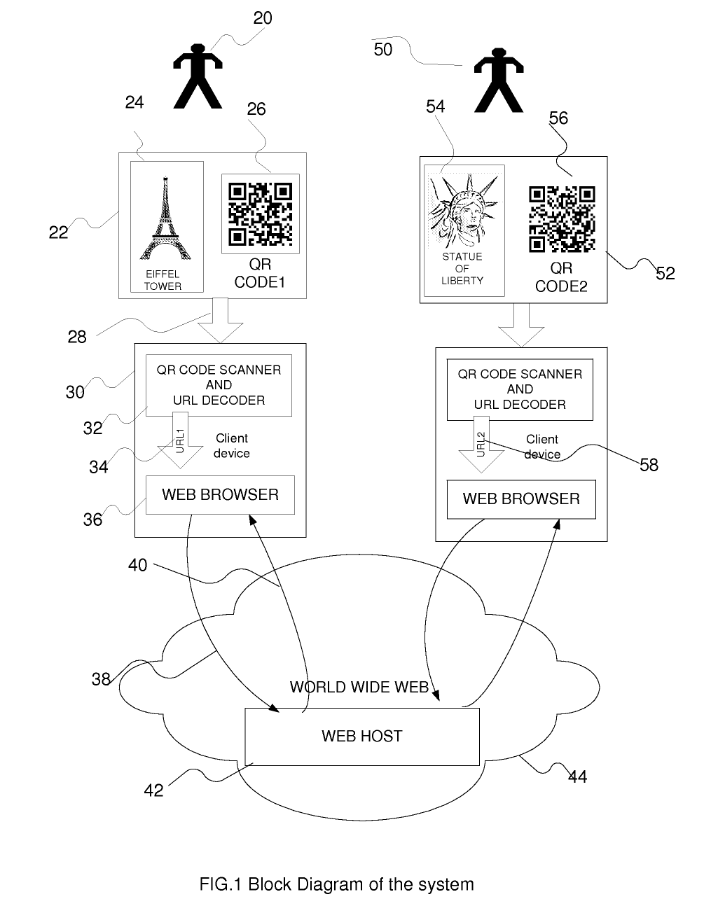

In one embodiment, the game is called the “Around the World in a Cup”. The subject theme of the game is “Cities of the World”. A set of utensils used for drinking or eating are used as game pieces. Each utensil in the set is imprinted with a drawing and a corresponding QR code object. These game pieces are distributed among one or more players. FIG. 1 shows the elements of the game using two players as an example. A first player (20) has a game piece (22) comprising a drawing object of Eiffel tower (24) and corresponding instance of the QR code object (26) encoding a URL string URL1 (34). A second player has a second game piece (52) imprinted with a drawing object of Statue of Liberty (54) and a corresponding QR code object (56) encoding a URL string URL2 (58). Thus, each game piece in the set have different drawing objects and the correspondingly different QR code objects. Game play starts by players using their client device (30). The software application (32) with the camera on the client device is used to scan the QR code and decode the string URL1 (34). The URL thus decoded is communicated to the web browser (36) on the client device. The web browser then transmits the request (38) to a designated web host (42) on the World Wide Web (44). A first web page (40) corresponding to the requested URL1 stored in the web host (42) is served back to the client device (30). Client device (30) then displays the web page on the screen of the client device using the web browser application therein. The said first web page may have a choice of instructions in text, multimedia objects, and links to other web pages. Player has a choice of links on the first web page to navigate to subsequent web pages each containing further text and multimedia objects. Player may decide to navigate to one of the choices depending on the rules agreed to between the players.

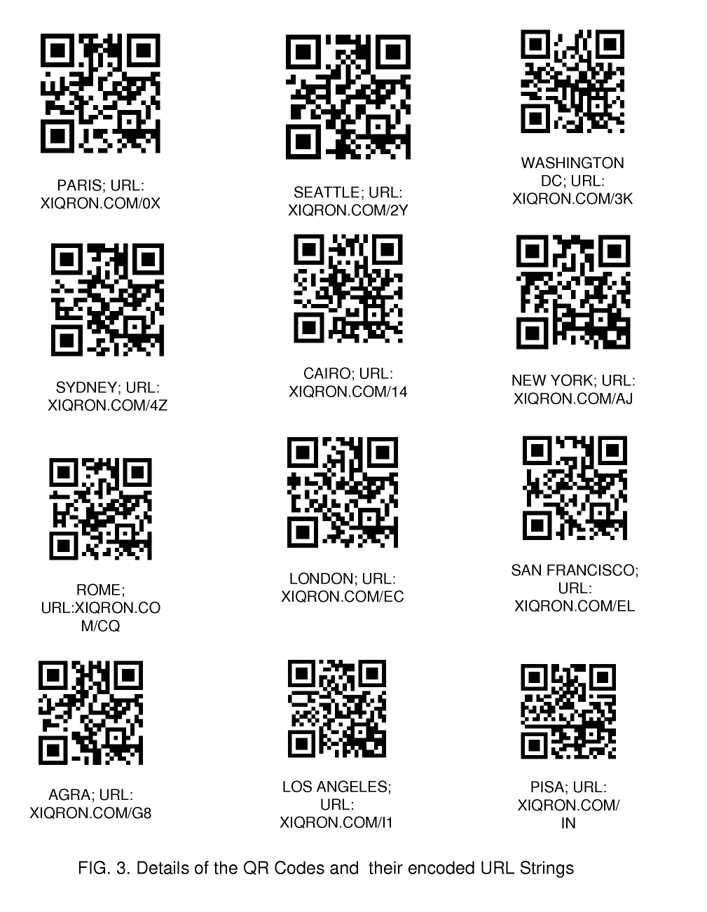

The web host may insert additional dynamic content such as advertisements along with the core content related to the game. The QR Codes along with the URLs that were used for the preferred embodiment are shown in FIG. 3. Preferred embodiment uses short URL strings in order to reduce the density of the QR code and subsequently increase the speed and accuracy of scanning the QR code. Preferred embodiment uses a two letter suffix as part of the encoded URL to identify the first webpage for each game piece. Said suffix is a pseudo random string that is uniquely mapped to a given game piece. Mapping the name of the city to a randomized suffix makes it difficult for players to guess an opponent's webpage URL and be able to cheat by going to the other team player's web page. As an example the webpage for the game piece on Paris is mapped to XIQRON.COM/OX instead of the more obvious XIQRON.COM/PARIS. Shortened suffixes also result in a shorter URL and a less dense QR code thereby increasing a quicker scan.

The game is described here with two players to keep the description and the figures simple. The game is similarly extended to multiple players.

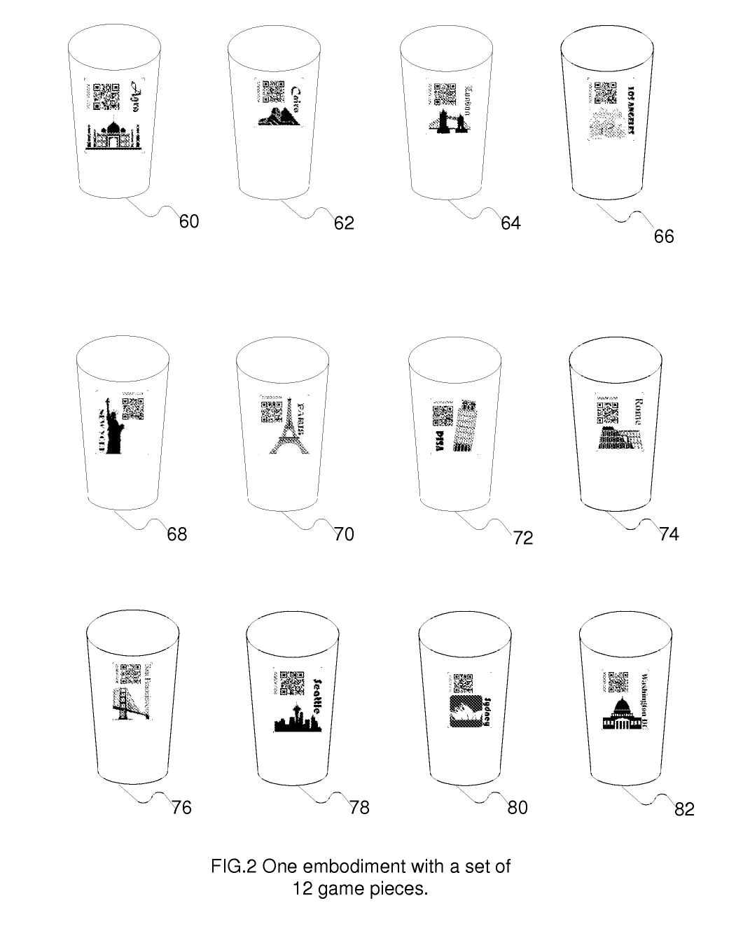

FIG. 2 shows a set of 12 game pieces (60, 62, 64, 66, 68, 70, 72, 74, 76, 78, 80, 82) used in the preferred embodiment.

In another embodiment, a subset of utensils used for drinking or eating used as game pieces share the same drawing and QR code. The utensils used for drinking or eating within the subset are distinct by way of their shape, background color or some other visual characteristic. Visually distinct game pieces allow the players to easily identify their game piece. Game play proceeds by each player selecting questions not already covered by previous players, or by selecting different sets of questions accessed from the first web page.

1) A game comprising:
a) a set of game pieces, each said game piece comprising a physical object, at least a drawing object, and at least a Quick Response (QR) code object;
b) said QR code object encoding a Unified Resource Locator (URL);
c) said drawing object comprising drawing, text, painting, photo image, sketch or a combination thereof;
d) a web host on the World Wide Web (WWW) storing and serving a set of first web pages corresponding to received said URLs.

2) Game of claim 1 wherein said physical object is a utensil used for drinking or eating.

3) Game of claim 1 wherein said drawing object and said QR code object are imprinted on said game piece.

4) Game of claim 1 wherein said drawing object and said QR code object are detachably attached to said game piece.

5) Game of claim 1 wherein each game piece in said set of game pieces has a distinct encoded URL.

6) Game of claim 1 wherein a subset of game pieces have the same encoded URL and are distinct in said subset by color, size, shape or a combination thereof.

7) Game of claim 1 wherein the said first web page served from the web host comprises a set of questions, hints, answers, instructions, advertisements, multimedia objects, drawings, text objects, links to other web pages, or a combination thereof.

8) Game of claim 1 wherein a software application means resident on a client device that scans said QR code on said game piece, decodes the URL therein, sends the URL to said web host, and displays content of said web pages received from said web host.

9) Game of claim 1 wherein each said encoded URL is a text string not related to subject of said game thereby making it difficult for players to guess the URLs of other players.

10) A method of playing said game comprising:
a) a set of players each having a subset of said game pieces;
b) players each using said application software means to scan QR code on said game piece;
c) thereby receiving first web page and posing questions, or presenting information therein to other said players;
d) said players navigating to other web pages from said first web page;
e) said players keeping score for each correct answer.

11) Method of claim 9 wherein said set of players is one.
